(19) United States
(12) Patent Application Publication
(10) Pub. No.: US 2023/0065727 A1
(43) Pub. Date: Mar. 2, 2023

(54) VEHICLE AND VEHICLE CONTROL METHOD

(71) Applicants: Hyundai Motor Company, Seoul (KR); Kia Corporation, Seoul (KR)

(72) Inventors: Dong Geol YANG, Seoul (KR); Woo Young LEE, Seoul (KR)

(21) Appl. No.: 17/821,652

(22) Filed: Aug. 23, 2022

(30) Foreign Application Priority Data
Aug. 31, 2021 (KR) 10-2021-0115675

(51) Int. Cl. G01C 21/32; G01C 21/00; B60W 60/00; H04W 4/46; H04W 4/80

(52) U.S. Cl. CPC G01C 21/32; G01C 21/3822; G01C 21/3841; B60W 60/001; H04W 4/46; H04W 4/80; B60W 2420/42; B60W 2420/52; B60W 2556/20; B60W 2556/35; B60W 2556/40; B60W 2556/65

(57) ABSTRACT

A vehicle control method according to an embodiment includes selecting a target vehicle to share low-level sensor information with based on the low-level sensor information obtained by a host vehicle and information on a structure included in high-definition map information, and receiving low-level sensor information of the structure from the target vehicle to update a sensor data map of the host vehicle, and performing map matching with the high-definition map information through feature points of a road extracted based on the updated sensor data map.

### PRIORITY

The present application claims under 35 U.S.C. § 199(a) the benefit of Korean Patent Application No. 10-2021-0115675, filed on Aug. 31, 2021, which is hereby incorporated by reference as if fully set forth herein.

### BACKGROUND OF THE DISCLOSURE

### Field of the Disclosure

Embodiments relate to a vehicle that recognizes a surrounding environment and a vehicle control method.

### Discussion of the Related Art

The core of technical development of autonomous vehicle driving and advanced driver assistance systems (ADAS) may be technology for acquiring accurate and reliable information on surrounding environments.

In order to detect a surrounding environment, various sensors such as a camera, a radar sensor, and a lidar sensor may be used in vehicles, and methods for fusing information between different types of sensors to improve recognition performance may be being used.

However, when an obstacle such as another vehicle or a screen fence may be positioned around a vehicle, sensor occlusion occurs and thus it may be difficult to accurately recognize a surrounding environment.

### SUMMARY OF THE DISCLOSURE

Embodiments provide a vehicle and a vehicle control method capable of accurately recognizing a surrounding environment through data sharing between vehicles separated by a short distance even when sensor occlusion due to surrounding obstacles occurs.

The technical problem to be solved in embodiments may not be limited to the technical problem mentioned above, and other technical problems that may not be mentioned will be clearly understood by those of ordinary skill in the art to which the present disclosure belongs from the description below.

To achieve these objects and other advantages and in accordance with the purpose of the disclosure, as embodied and broadly described herein, a vehicle control method may include selecting a target vehicle to share low-level sensor information with based on the low-level sensor information obtained by a host vehicle and information on a structure included in high-definition map information, and receiving low-level sensor information of the structure from the target vehicle to update a sensor data map of the host vehicle, and performing map matching with the high-definition map information through feature points of a road extracted based on the updated sensor data map.

For example, the selecting of the target vehicle may include determining whether sensor occlusion has occurred in a sensor beam section, and selecting the target vehicle based on the low-level sensor information obtained in the corresponding section when sensor occlusion has occurred.

For example, the determining of whether sensor occlusion has occurred may include calculating an intersection point between a center line of a sensor beam section and the structure included in the high-definition map information, calculating a distance between the intersection point calculated from the high-definition map information and low-level sensor information obtained from the sensor beam section, and determining that sensor occlusion has occurred in the corresponding sensor beam section if the distance may be equal to or greater than a reference distance.

For example, the selecting of the target vehicle may include checking classification information (classification) and moving attribute information (moving flag) of low-level sensor information obtained in the section where sensor occlusion has occurred, and selecting the corresponding vehicle as the target vehicle when the classification may be set to “car” and the moving flag may be “moving”.

For example, the receiving of low-level sensor information of the structure from the target vehicle to update a sensor data map of the host vehicle, and performing of map matching with the high-definition map information through feature points of a road extracted based on the updated sensor data map may include broadcasting a communication ID and GPS-based location information of the host vehicle, requesting one-to-one communication from a vehicle having location information of the target vehicle, and receiving the low-level sensor information of the structure from the target vehicle.

For example, the receiving of the low-level sensor information of the structure from the target vehicle to update the sensor data map of the host vehicle may include calculating confidence based on at least one of classification information (classification), moving attribute information (moving flag), data confidence (quality), and sensor measurement value distance information (range) included in the low-level sensor information received from the target vehicle, and updating corresponding low-level sensor information to the sensor data map when the calculated confidence may be equal to or greater than a threshold value.

For example, the calculating of confidence may include calculating higher confidence as a distance of the sensor measurement value distance information (range) becomes shorter.

For example, the vehicle control method may further include obtaining the low-level sensor information using at least one of a camera and a radar, and generating a sensor data map of the host vehicle using the low-level sensor information, wherein the receiving of the low-level sensor information of the structure from the target vehicle may include receiving low-level sensor information obtained using at least one of a camera and a radar of the target vehicle.

For example, the performing of map matching with the high-definition map information through feature points of a road extracted based on the updated sensor data map may include obtaining low-level sensor information using a lidar, generating sensor fusion data by fusing the updated sensor data map and the low-level sensor information of the lidar, and extracting the feature points of the road based on the sensor fusion data.

For example, the sensor data map may be generated by storing probability that the low-level data may be obtained at a specific position in the form of a grid map based on the low-level data.

For example, a size of the sensor data map may be determined in advance on the basis of track data and low-level data of a radar and a camera, and information accumulated from a start time at which the low-level data may be obtained to a time t may be stored in the sensor data map.

For example, the sensor data map may be updated in such a manner that the low-level information received from the target vehicle may be accumulated and updated in a corresponding cell.

In another embodiment of the present disclosure, a recording medium recording a program for executing a vehicle control method, wherein the program implements a function of selecting a target vehicle to share low-level sensor information based on the low-level sensor information obtained by a host vehicle and information on a structure included in high-definition map information, and a function of receiving low-level sensor information of the structure from the target vehicle to update a sensor data map of the host vehicle, and performing map matching with the high-definition map information through feature points of a road extracted based on the updated sensor data map, may be read by a computer.

In another embodiment of the present disclosure, a vehicle may include a sensor unit configured to obtain low-level information on objects around the vehicle, a communication unit configured to transmit/receive data to/from other vehicles through short-range communication, and a controller configured to select a target vehicle to share low-level sensor information based on the low-level sensor information obtained through the sensor unit and information on a structure included in high-definition map information, to receive low-level sensor information of the structure from the target vehicle through the communication unit to update a sensor data map of the host vehicle, and to perform map matching with the high-definition map information through feature points of a road extracted on the basis of the updated sensor data map.

For example, the controller may be configured to calculate an intersection point between the structure included in the high-definition map information and a center line of a sensor beam section, calculate a distance between the intersection point calculated from the high-definition map information and low-level sensor information obtained in the sensor beam section, and determine that sensor occlusion has occurred in the sensor beam section if the distance may be equal to or greater than a reference distance to select the target vehicle.

For example, the controller may be configured to check classification information (classification) and moving attribute information (moving flag) of low-level sensor information obtained in a section where sensor occlusion has occurred, and select the corresponding vehicle as the target vehicle when classification may be set to “car” and the moving flag may be “moving”.

For example, the controller may be configured to calculate confidence based on at least one of classification information (classification), moving attribute information (moving flag), data confidence (quality), and sensor measurement value distance information (range) included in the low-level sensor information received from the target vehicle and update corresponding low-level sensor information to the sensor data map when the calculated confidence may be equal to or greater than a threshold value.

For example, the communication unit may broadcast a communication ID and GPS-based location information of the host vehicle according to control of the controller, request one-to-one communication from a vehicle having location information of the target vehicle, and receive low-level sensor information of the structure from the target vehicle.

For example, the sensor unit may include at least two of a lidar sensor, a camera sensor, and a radar sensor.

The vehicle and the vehicle control method according to embodiments may accurately recognize a surrounding environment by improving the effect of sensor occlusion through data sharing between vehicles separated by a short distance.

In addition, the vehicle and the vehicle control method according to the embodiments may reduce positioning error of a host vehicle during map matching by acquiring accurate and reliable information about a surrounding environment.

It will be appreciated by persons skilled in the art that the effects that may be achieved with the present disclosure may not be limited to what has been particularly described hereinabove and other advantages of the present disclosure will be more clearly understood from the following detailed description.

### BRIEF DESCRIPTION OF THE DRAWINGS

FIG. 1 is a diagram for describing sensing ranges of sensors included in a vehicle according to an embodiment.

FIGS. 2A-2B are a diagram for describing the concept of sharing data between vehicles at a short distance according to an embodiment.

FIG. 3 is a schematic block diagram of a vehicle according to an embodiment.

FIG. 4 is a diagram for describing a method of generating a sensor data map of a vehicle according to an embodiment.

FIGS. 5 to 7 are diagrams for describing a method of sharing sensor data according to an embodiment.

FIGS. 8 to 11B are diagrams for describing a method of updating a sensor data map of a vehicle according to an embodiment.

FIG. 12 is a diagram for describing a control flow of a vehicle according to an embodiment.

### DETAILED DESCRIPTION OF THE DISCLOSURE

Hereinafter, embodiments of the present disclosure will be described in detail with reference to the accompanying drawings to aid in understanding of the present disclosure. However, embodiments according to the present disclosure may be modified in various manners, and the scope of the present disclosure should not be construed as being limited to the embodiments described below. The embodiments of the present disclosure may be provided in order to more completely explain the present disclosure to those of ordinary skill in the art.

In description of embodiments, when an element may be described as being formed on “on” or “under” of another element, “on” or “under” includes a case where both elements may be in direct contact with each other or a case in which one or more other elements may be indirectly disposed between the two elements.

In addition, in the case of representation of “on” or “under”, it may include the meaning of the downward direction as well as the upward direction based on one element.

Further, relational terms such as “first”, “second,” “top”/“upper”/“above” and “bottom”/”lower/”under” used below may be used to distinguish a certain entity or element from other entities or elements without requiring or implying any physical or logical relationship between entities or order thereof.

Hereinafter, a vehicle and a vehicle control method according to each embodiment of the present disclosure will be described with reference to the drawings.

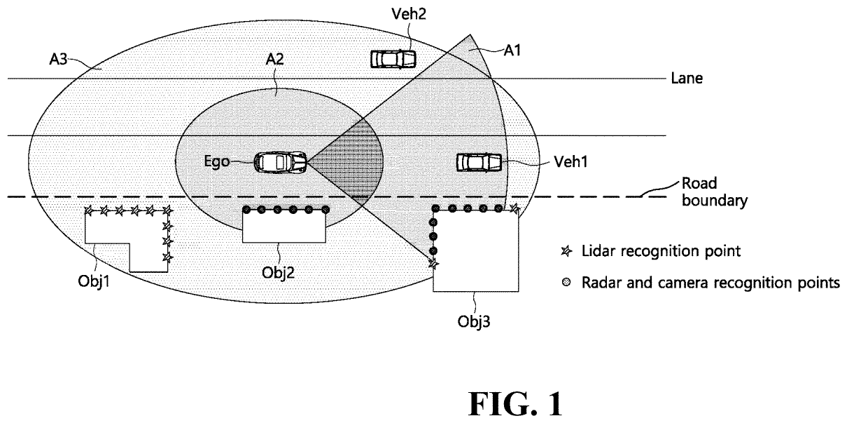

FIG. 1 is a diagram for describing sensing ranges of sensors included in a vehicle according to an embodiment.

A host vehicle Ego may determine the current location thereof by detecting feature points that may be discovered in the vicinity of a road during autonomous driving and matching the same with a high-definition map. As the feature points around the road, structures around the road, such as buildings Obj1, Obj2, and Obj3, a road boundary, and a pier may be applied.

Referring to FIG. 1, the host vehicle Ego according to an embodiment may include a plurality of sensors for sensing surrounding objects. The sensors may have different sensing areas A1, A2, and A3 and may be the same type of sensors or different types of sensors. The embodiment of FIG. 1 illustrates a case in which first to third sensors for sensing the first to third sensing areas A1 to A3 may be used. In this description, a case in which the first sensor may be a camera, the second sensor may be a radar, and the third sensor may be a lidar will be exemplified.

The camera that senses the first sensing area A1 may acquire a front view image of the host vehicle Ego through an image sensor. Image information captured by the camera may provide information such as a shape of an object and a distance to the object. Although the camera acquires a front view image of the host vehicle Ego in FIG. 1, the present disclosure may not be limited thereto.

The radar that senses the second sensing area A2 may measure a distance between the host vehicle Ego and a neighboring object. The radar generates electromagnetic waves, such as radio waves and microwaves and receives electromagnetic waves reflected from a neighboring object to ascertain a distance to the neighboring object, a direction and an altitude of the neighboring objects, and the like.

The lidar that senses the third sensing area A3 may measure a distance between the host vehicle Ego and a neighboring vehicle. The lidar may calculate spatial location coordinates of a reflection point by scanning a laser pulse and measuring an arrival time of a laser pulse reflected from a neighboring vehicle, thereby ascertaining a distance to the neighboring vehicle and a shape of the neighboring vehicle. The lidar radiates a laser beam such as infrared or visible light having a shorter wavelength than electromagnetic waves radiated by the radar and may sense a relatively wide area as compared to the radar.

The camera, the radar, and the lidar may generate low-level data in the form of a detection point by sensing an object through respective methods.

Since the first building Obj1 may be located in the third sensing area A3, it may be recognized only by the lidar. Since the second building Obj2 may be located in an area where the second sensing area A2 and the third sensing area A3 overlap, it may be recognized by the radar and the lidar.

A part of the third building Obj3 may be located in an area where the first sensing area A1 and the third sensing area A3 overlap and thus may be recognized by the lidar and the camera, another part thereof may be located in the third sensing area A3 and thus may be recognized only by the lidar, and the remaining part may be located outside the sensing areas and thus may not be recognized.

In this way, low-level data recognized by each sensor for the same object may be acquired, and thus the performance of recognition of structures may be improved by fusing the low-level data acquired from the camera, the radar, and the lidar.

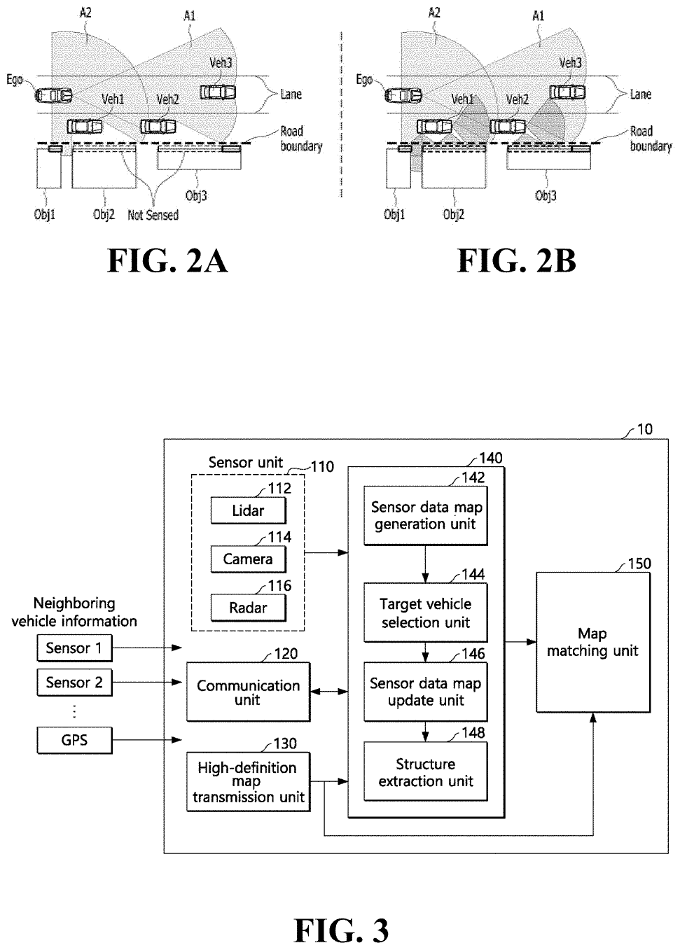

FIGS. 2A-2B are a diagrams for describing the concept of sharing data between a vehicle and a vehicle at a short-distance according to an embodiment.

Referring to FIG. 2A, the host vehicle Ego may sense other vehicles Veh1, Veh2, and Veh3 located in the first sensing area A1 and the second sensing area A2 and structures around a road during traveling. In (a), the structures around the road may include buildings Obj1, Obj2, and Obj3 and a road boundary.

Since a part of the first building Obj1 may be located in the second sensing area A2, the host vehicle Ego may recognize the part of the first building Obj1.

The second building Obj2 may be located in the second sensing area A2. However, since the other vehicle Veh1 may be located between the host vehicle Ego and the second building Obj2, sensor occlusion may occur. Accordingly, the host vehicle Ego cannot recognize the second building Obj2.

The third building Obj3 may be located in the first sensing area A1. However, since the other vehicle Veh2 may be located between the host vehicle Ego and the third building Obj3, sensor occlusion may occur. Accordingly, the host vehicle Ego may recognize only a partial area of the third building Obj3.

Referring to FIG. 2(b), the other vehicle Veh1 located between the host vehicle Ego and the second building Obj2 may acquire sensor data of the second building Obj2 which cannot be sensed by the host vehicle Ego.

In addition, the other vehicle Veh2 located between the host vehicle Ego and the third building Obj3 may acquire sensor data of the third building Obj3 which cannot be sensed by the host vehicle Ego.

Accordingly, the present embodiment may improve the accuracy of map matching by sharing sensor data between vehicles at a short distance such that structures around a road that may not be sensed due to sensor occlusion may also be recognized. The range of vehicles at a short distance, which may be information sharing targets, may be set to about a distance between both ends of a four-lane road. For example, since a normal lane width may be 2.75 m to 3.5 m, the range may be set such that vehicles located within an approximate radius of 30 m may share sensor data. Such a communication radius may be variably set in consideration of data load that may occur during communication between vehicles, a road width, and the like.

FIG. 3 is a schematic block diagram of a vehicle 10 according to an embodiment.

Referring to FIG. 3, the vehicle 10 according to the embodiment includes a sensor unit 110, a communication unit 120, a high-definition map transmission unit 118, a sensor data processing unit 140, and a map matching unit 150.

The sensor unit 110 may detect objects located in front, beside, and behind the host vehicle and detect a speed and an acceleration of a detected object. The sensor unit 110 may include a variety of sensors, such as a lidar 112, a camera 114, and a radar provided at the front, side, and rear of the host vehicle.

The lidar 112 may measure a distance between the host vehicle and a neighboring object. The lidar 112 may calculate spatial location coordinates of a reflection point to ascertain a distance to a neighboring object and a shape of the neighboring object by scanning a laser pulse and measuring an arrival time of a laser pulse reflected from the neighboring object.

The camera 114 may acquire images around the host vehicle through an image sensor. The camera 114 may include an image processor that performs image processing such as noise removal, image quality and saturation adjustment, and file compression on an acquired image.

The radar 116 may measure a distance between the host vehicle and a neighboring object. The radar 124 may generate electromagnetic waves in the vicinity of the host vehicle and receive electromagnetic waves reflected from a neighboring objects to check the distance to the neighboring object, the direction and altitude of the neighboring object.

The communication unit 120 includes devices for data communication with the outside. The communication unit 120 may include a GPS device for receiving GPS information, and various devices capable of transmitting/receiving sensor data to/from neighboring vehicles through a short-range communication method. For example, the communication unit 120 may include a V2X communication unit capable of executing wireless communication functions between the vehicle and all entities, such as vehicle-to-vehicle or vehicle-to-infrastructure communication.

The high-definition map transmission unit 118 transmits a high-definition (HD) map that provides information on roads and surrounding geographical features. The HD Map may provide information on structures around roads, such as traffic lights, signs, curbs, piers, and buildings, as well as information on lanes, such as road centerlines and boundaries. The HD map may be stored in the form of a database (DB) and may be automatically updated at regular intervals using wireless communication or may be manually updated by a user.

The sensor data processing unit 140 extracts information on structures around a road based on sensor data obtained from the sensor unit 110 and sensor data obtained by another vehicle 20 and received through the communication unit 120. The sensor data processing unit 140 reflects the sensor data acquired by the other vehicle 20 in an area where the host vehicle cannot obtain the sensor data to recognize structures around the road, thereby solving a problem that the structure around the road cannot sensed due to sensor occlusion. The sensor data processing unit 140 includes a sensor data map generation unit 142 that generates a probability grid map using sensor data, a target vehicle selection unit 144 that selects another vehicle to share sensor data, a sensor data map update unit 146 that updates sensor data obtained from the other vehicle to a sensor data map, and a structure extraction unit 148 that extracts information on structures around a road based on the sensor data map. A detailed configuration of the sensor data processing unit 140 will be described later in detail.

The map matching unit 150 may match the HD map with information on structures around a road extracted by the sensor data processing unit 140 and output location information of the host vehicle.

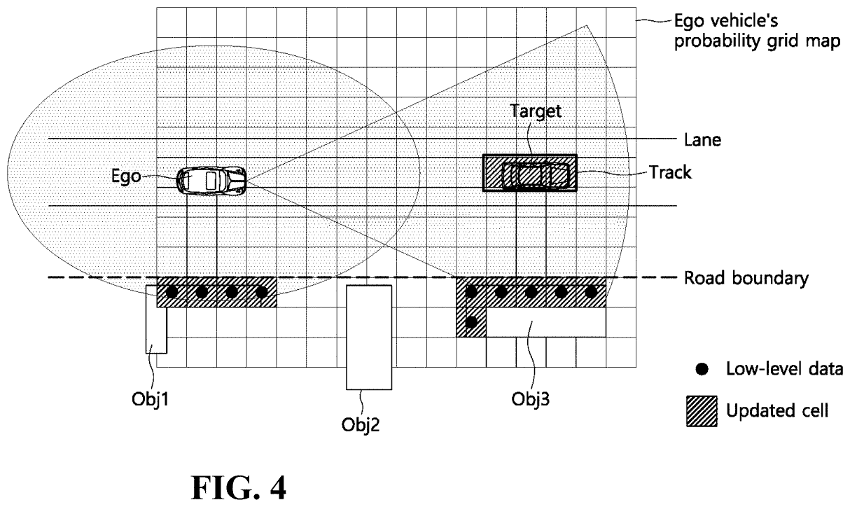

A detailed configuration of the sensor data processing unit 140 of FIG. 3 will be described in detail with reference to FIGS. 4 to 10B. The sensor data processing unit 140 may include the sensor data map generation unit 142, the target vehicle selection unit 144, the sensor data map update unit 146, and the structure extraction unit 148. Since the sensor data processing unit 140 recognizes a structure around a road by fusing information sensed by the lidar 112, the camera 114, the radar 116, and the like, data shared with other vehicles may be at least one of sensor data of the lidar, sensor data of the camera, and sensor data of the radar. However, since lidar data has a large amount of cloud point information, a high system load may occur at the time of transmitting/receiving and updating sensor data. Accordingly, in the present embodiment, a case in which sensor data of the camera and the radar may be shared and then lidar data may be fused to recognize an object will be exemplified.

FIG. 4 is a diagram for describing a method of generating a sensor data map of a vehicle according to an embodiment and illustrates a method of generating a sensor data map by the sensor data map generation unit 142 of FIG. 3.

Referring to FIG. 4, the sensor data map generation unit 142 generates a sensor data map, which may be a probability grid map of the host vehicle Ego, using sensor data obtained from the first sensing area A1 of the camera 114 and the second sensing area A2 of the radar 116.

The sensor data map generation unit 142 generates a probability based data map having a predefined size using track data and low-level data of the camera 114 and the radar 116. The low-level data may include tracklet information representing tracked movements of objects, a free space that may be an area in which the host vehicle may travel within a given range in front of the camera, occupancy distance map (ODM) information, etc.

The camera 114 and the radar 116 may acquire low-level data in the form of one point per beam section within each field of view (FOV) range. Each point may have information such as location, speed, classification, and confidence. The low-level data obtained from the camera 114 and the radar 116 may be cumulatively updated in cells of the sensor data map from a start time to a time t. FIG. 4 illustrates an example in which cells of the sensor data amp may be updated according to low-level data of the first building Obj1 obtained in the second sensing area A2 of the host vehicle Ego and low-level data of the third building Obj3 obtained in the first sensing area A1.

Since cells may be independent of each other, the probability of the entire map may be calculated as the product of probabilities of the respective cells. This may be represented as the following equations.

p(m)=Πᵢp(mₜ) <Equation 1>

p(m|z_{1:t},x_{1:t})=Πᵢp(mᵢ|z_{1:t},x_{1:t}) <Equation 2>

mᵢ: Probability value of each cell of data map

z_{1:t}: Sensor data at time t

x_{1:t}: Location of host vehicle at time t

In Equation 1, p(m) represents the probability of the entire sensor data map. Since cells may be independent of each other, the probability of the entire sensor data map may be calculated as the product of probabilities of respective cells.

Equation 2 represents estimation of the probability of the sensor data map using given sensor data z_{1:t} and the location of the host vehicle x_{1:t} from the start time (1) to the time t (1:t).

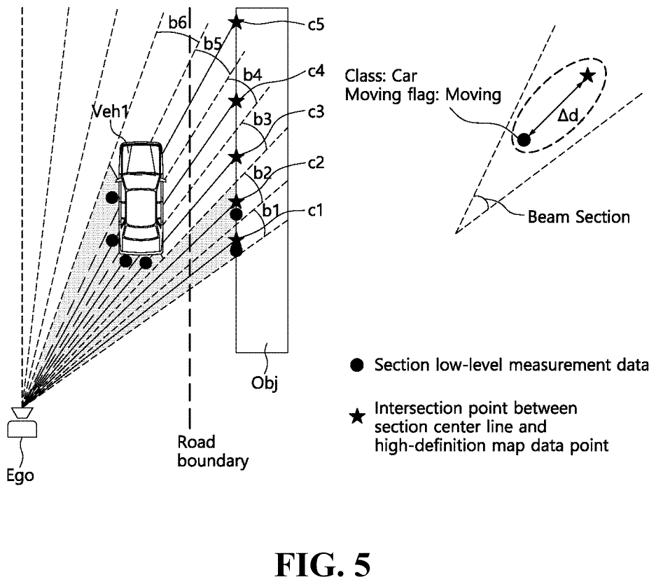

FIGS. 5 to 7 are diagrams for describing a method of sharing sensor data according to an embodiment. The target vehicle selection unit 144 of FIG. 3 determines whether a structure cannot be sensed due to sensor occlusion and requests sharing of sensor data of the structure with a target vehicle that has obtained the sensor data of the structure, thereby obtaining the sensor data from the target vehicle.

FIG. 5 is a diagram for describing a method of determining whether sensor occlusion occurs and selecting a target vehicle to share sensor data.

Referring to FIG. 5, when another vehicle Veh1 may be located between the host vehicle Ego and a structure Obj near a road, sensor occlusion occurs and thus sensor data of the structure Obj cannot be obtained in an area blocked by the other vehicle Veh1. Whether sensor occlusion has occurred may be determined by checking whether a road structure present on the HD map may be being normally sensed.

In order to check whether the road structure may be being normally sensed, intersection points obtained when sensor beams b1, b2, b3, b4, and b5 have normally arrived at the structure Obj on the HD Map may be calculated. The intersection points between the structure Obj and the sensor beams b1, b2, b3, b4, and b5 may be calculated based on center lines c1, c2, c3, and c4 of sensor beam sections b1, b2, b3, b4, b5, and b6. Low-level data may be acquired for each of the sensor beam sections b1, b2, b3, b4, b5, and b6 at the same position. A distance Δd between the intersection points between the structure Obj and the sensor beams b1, b2, b3, b4, and b5 calculated based on the HD map and actually measured low-level data may be calculated.

If the road structure Obj may be present in a specific sensor beam section based on the HD map, but the distance Δd from the sensor measurement value in the sensor beam section may be greater than a certain threshold value, it may be determined that sensor occlusion has occurred between the host vehicle Ego and the structure Obj from the corresponding beam section. The threshold value for determining whether sensor occlusion has occurred may be variably set based on the distance between a GPS based position of the host vehicle Ego and the structure Obj.

On the other hand, if the distance Δd between the intersection points between the structure Obj and the sensor beams b1, b2, b3, b4, and b5 calculated based on the HD map and the actually measured low-level data may be equal to or greater than the threshold value, it may be determined that sensor occlusion has occurred, but an error may have occurred at a sensor position. Accordingly, it may be determined whether occlusion may be caused by a vehicle by checking data class and moving flag information of low-level information obtained from a beam section in which sensor occlusion may be determined to have occurred. When the data class may be a car and the moving flag information represents “moving”, the corresponding vehicle may be selected as a target vehicle to share sensor data.

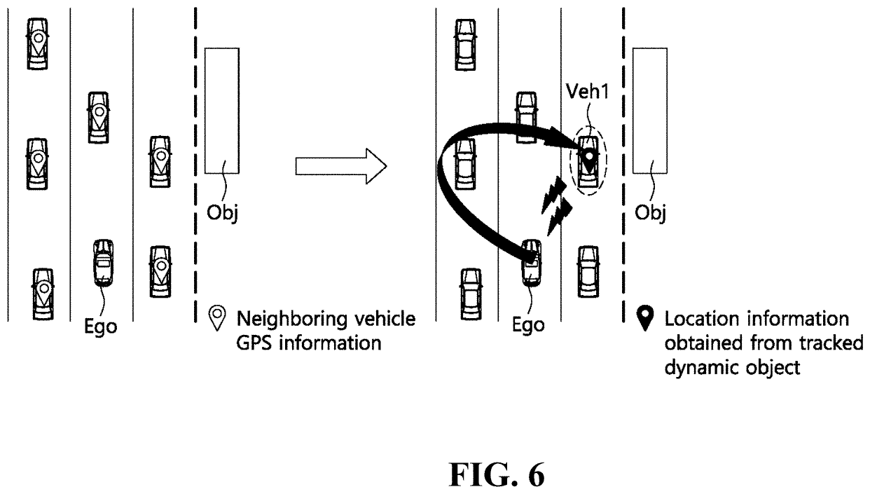

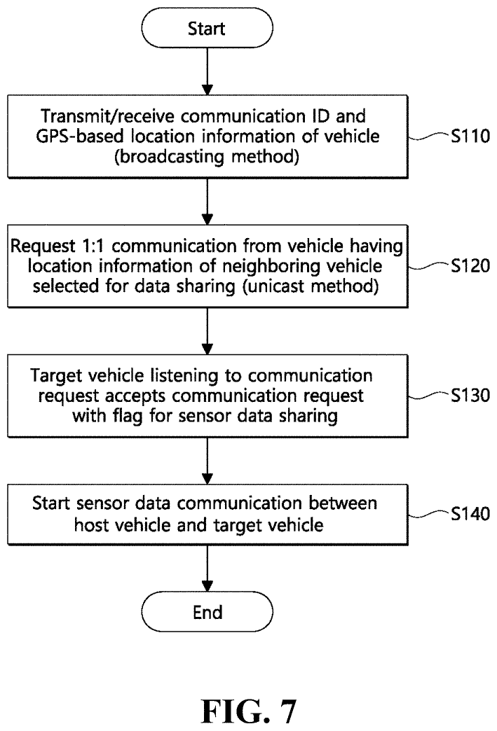

FIGS. 6 and 7 are diagrams for describing a method of sharing sensor data with a target vehicle.

Referring to (a) of FIG. 6, when a target vehicle to share sensor data may be selected, GPS information on neighboring vehicles present within a predetermined area around the host vehicle Ego may be received.

Referring to (b) of FIG. 6, a vehicle having GPS information closest to the location information of the vehicle selected as the target vehicle may be determined, and sensor data may be received from the vehicle.

FIG. 7 is a flowchart of a method of receiving sensor data from a target vehicle using a vehicle-to-vehicle method.

A communication ID and GPS-based location information of the host vehicle Ego may be transmitted and received in a broadcasting manner (S110). Here, vehicles around the host vehicle Ego may be set such that they accept a communication request with a flag for sharing sensor data.

A request for one-to-one communication (unicast) may be sent to the vehicle Veh1 having the GPS information closest to the location information of the vehicle that has been selected as the target vehicle (S120).

The target vehicle that may be listening to a communication request of the host vehicle Ego may accept the communication request having a flag for sharing sensor data (S130).

Accordingly, sensor data communication between the host vehicle Ego and the target vehicle Veh1 may be performed (S140).

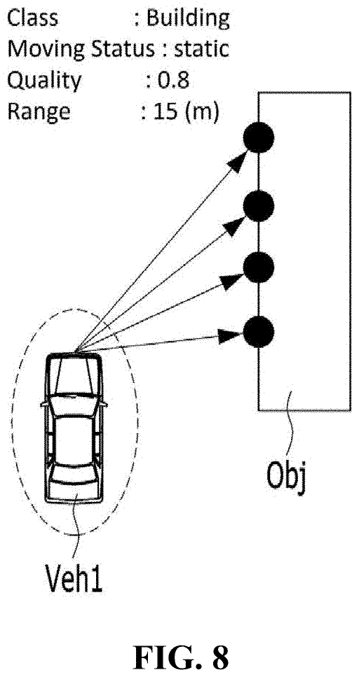

FIGS. 8 to 11 are diagrams for describing a method of updating a sensor data map of a vehicle according to an embodiment. A method in which the sensor data map update unit 146 of FIG. 3 reflects sensor data received from a target vehicle in the sensor data map of the host vehicle will be described with reference to FIGS. 8 to 11.

Referring to FIG. 8, sensor data received from a target vehicle Veh1 through a vehicle-to-vehicle method may include classification information, moving attribute information (moving flag), data confidence (quality), and sensor measurement value distance information (range).

The sensor data received from the target vehicle Veh1 may be data of a structure Obj that may not be sensed by the host vehicle Ego. Accordingly, the received sensor data may have classification of “building”, a moving flag of “static”, a quality value (e.g., 0.8) guaranteed by the target vehicle Veh1, and a sensor measurement distance (e.g., 15 m) of the target vehicle Veh1.

Since such information of the sensor data has been set when the target vehicle Veh1 has sensed the corresponding data, the host vehicle Ego may calculate confidence by synthesizing the classification information, movement attribute information (moving flag), data confidence (quality), and sensor measurement value distance information (range) of the sensor data received from the target vehicle Veh1.

The following equation may be an equation defined to calculate Confidenceₛₑₙₛₒᵣ of the sensor data received by the own vehicle Ego.

Confidenceₛₑₙₛₒᵣ=Quality×Certainty_{range}×p(class=road structure)×p(moving flag=static)×100(%) <Equation 3>

In the above equation, each variable may be set as follows.

Quality: Confidence information of sensor itself (Range: 0 to 1)

Certainty_{range}: Certainty reflecting distance information between sensor and object (Range: 0 to 1)

p(class=road structure): Whether class information of sensor corresponds to road structure (0 or 1)

p(class=static): Whether moving attribute information of sensor may be in static state (0 or 1)

Among the variables, Certainty_{range} may be applied by calculating certainty according to distance by applying linear interpolation such that the closer the distance of an object detected by a sensor is, the higher the confidence may be calculated.

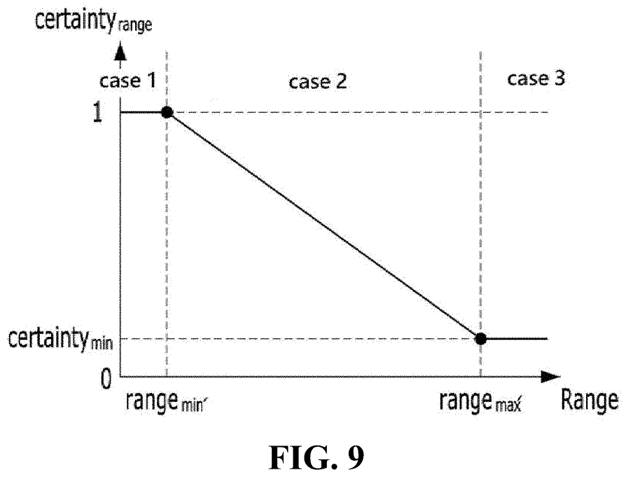

FIG. 9 is a graph showing a relationship between certainty and a distance between a sensor and a sensed object.

Among the variables of Equation 3, certainty range may be set by reflecting sensor characteristics and field of view (FOV).

As shown in the graph of FIG. 9, certainty certainty_{range} reflecting distance information between a sensor and an object may be set to a minimum certainty value certaintyₘᵢₙ to a maximum value of 1 between a minimum range range_{min′}, and a maximum range rangeₘₐₓ′ between the sensor and the object. Here, the minimum range range_{min′}, the maximum range range_{max′} and the minimum certainty certaintyₘᵢₙ between the sensor and the object may be set by reflecting sensor characteristics and FOV indicating the observable range of the sensor.

Referring to FIG. 9, the certainty certainty_{range} reflecting distance information between the sensor and the object according to the range between the sensor and the object may be expected in the following three cases.

$$Case 1 ) range < {range}_{min} , {Certainty}_{range} = 1$$

$$Case 2 ) {range}_{min} < range < {range}_{max} , {Certainty}_{range} = \frac{1 - {Certainty}_{min}}{{range}_{max} - {range}_{min}} ( range - {range}_{max} ) + {Certainty}_{min}$$

$$Case 3 ) {range}_{max} < range , {Certainty}_{range} = {Certainty}_{min}$$

In case 1), since the range between the sensor and the object may be sufficiently close within the minimum range range_{min′}, the certainty certainty_{range} may be set to 1.

In case 3), since the range between the sensor and the object may be sufficiently close within the maximum range range_{max′}, the certainty certainty_{range} may be set to 1.

Case 2) may be a case in which the range between the sensor and the object varies between the minimum range range_{max′}, and the maximum range range_{max′}. In case 2), the certainty certainty_{range} reflecting distance information between the sensor and the object may be calculated using linear interpolation based on certaintyₘᵢₙ in the case of the minimum range range_{min′} and the certainty of 1 in the case of the maximum range range_{max′}, as shown in the above equation.

As described above, the sensor data map update unit 146 of the embodiment may calculate confidence confidenceₛₑₙₛₒᵣ of sensor data received by the host vehicle Ego, and only sensor data having calculated confidence equal to or greater than a predetermined threshold value may be updated to the sensor data map of the host vehicle Ego.

When the sensor data map may be updated, probability values may be increased by allowing duplicate updates for cells of the data map in which measurement values are sensed from a plurality of sensors.

This may be represented by the following equation 4.

Updated_p(m|z_{1:t},x_{1:t})=Πᵢ(p(mᵢ|z₁:t,x_{1:t})+p(mᵢ|neighbor_{z}_{_{1:t}},neighborₓ_{_{1:t}})) <Equation 4>

Updated_p(m|z_1:t, x_1:t) in Equation 4 represents update of probability of the sensor data map using given sensor data z_{1:t} and the location x_{1:t} of the host vehicle from the start time (1) to time t (1:t). As represented by Equation 4, the updated sensor data map may be generated by adding a probability value p(mᵢ|neighbor_{z1:t}, neighbor_{x1:t}) of sensor data received from a neighboring target vehicle to a probability value p(mᵢ|z_{1:t}, x_{1:t}) accumulated in the sensor data map in the host vehicle.

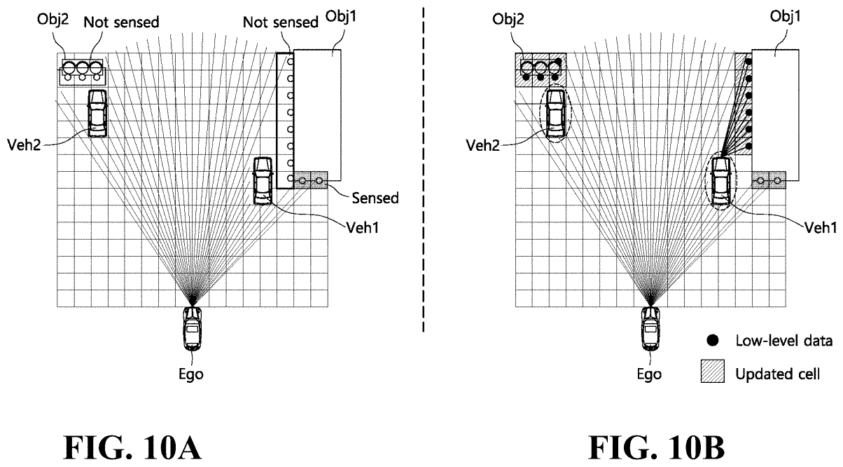

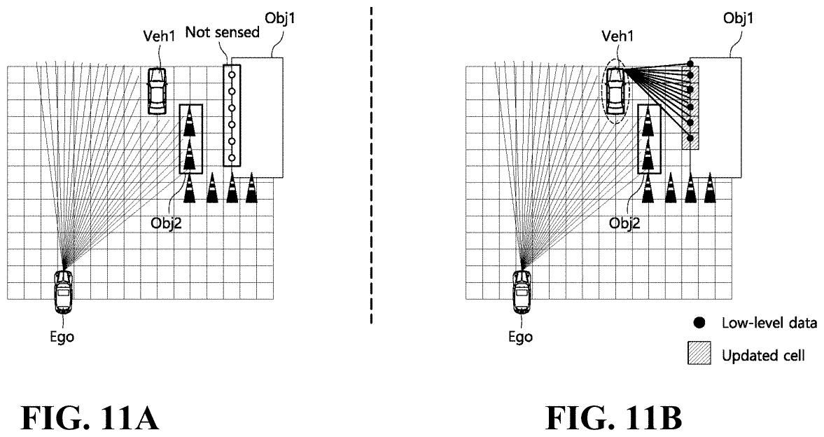

FIGS. 10A, 10B, and 11 are diagrams for describing a method of updating a sensor data map of a vehicle according to an embodiment.

Referring to FIG. 10A, the host vehicle Ego may sense preceding vehicles Veh1 and Veh2, and structures around a road such as a building Obj1 and a traffic light Obj2 while traveling.

A sensor of the host vehicle Ego may acquire low-level data in the form of one point per beam section within a field of view (FOV) range. Here, when another vehicle may be located between the structures Obj1 and Obj2 around the road and the host vehicle Ego, sensor occlusion may occur. As shown in FIG. 10(a), the host vehicle Ego cannot acquire sensing data of the traffic light Obj2 blocked by the other vehicle Veh2. In addition, sensing data cannot be acquired in a partial area of the building Obj1 that may be blocked by the other vehicle Veh1.

On the other hand, it may be inferred that the vehicle Veh1 has obtained sensing data of a part of the building Obj1 that may not be sensed by the host vehicle Ego, and the vehicle Veh2 has obtained sensing data of the traffic light Obj2. Accordingly, the host vehicle Ego may request sensor data sharing with the vehicles Veh1 and Veh2 and receive sensor data that may not be sensed by the host vehicle Ego.

Referring to FIG. 10B, the host vehicle Ego may obtain the sensing data of a part of the building Obj1, which may not be sensed by the host vehicle Ego, from the vehicle Veh1 and obtain the sensing data of the traffic light Obj2 from the vehicle Veh2. According to low-level data of the building Obj1 obtained from the vehicle Veh1 and low-level data of the traffic light Obj2 obtained from the vehicle Veh2, the cells of the sensor data map of the host vehicle Ego may be updated.

Referring to FIG. 11A, the host vehicle Ego may sense a preceding vehicle Veh1 and structure around a road, such as a building Obj1 and a color cone Obj2.

Although a structure that needs to be recognized by the host vehicle Ego as a road feature point may be the building (Obj1), the vehicle Veh1 and the color cone Obj2 may be located between the host vehicle Ego and the building Obj1, which may cause sensor occlusion. Accordingly, as shown in (a), the host vehicle Ego cannot obtain sensing data of the building Obj1. On the other hand, it may be inferred that the vehicle Veh1 has obtained the sensing data of the building Obj1 that may not be sensed by the host vehicle Ego. Accordingly, the host vehicle Ego may request sensing data sharing with the vehicle Veh1 and receive the sensing data that may not be sensed by the host vehicle Ego.

Referring to FIG. 11B, the host vehicle Ego may obtain sensing data of the building Obj1 that may not be sensed by the host vehicle Ego from the vehicle Veh1. Accordingly, the cells of the sensor data map of the host vehicle Ego may be updated according to low-level data of the building Obj1 obtained from the vehicle Veh1.

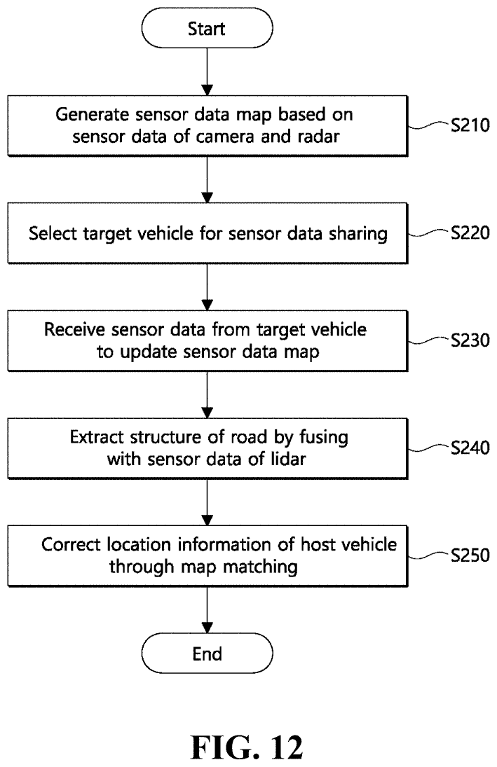

FIG. 12 is a diagram for describing a control flow of a vehicle according to an embodiment.

The vehicle according to the embodiment generates a sensor data map that may be a probability grid map thereof using sensor data obtained through a camera and a radar (S210).

When sensor occlusion may be detected, a target vehicle for sharing sensor data may be selected (S220). Upon determining that intersection points predicted when sensor beams have normally arrived at a structure on an HD map and low-level data obtained from an actual sensor may be data of a moving vehicle, the vehicle may be selected as a target vehicle to share sensor data.

When a target vehicle may be selected, the sensor data map may be updated by receiving sensor data from the target vehicle (S230). The sensor data may be received from the target vehicle through vehicle-to-vehicle communication. Confidence may be calculated for the received sensor data, and only sensor data having calculated confidence equal to or greater than a predetermined threshold value may be updated to the sensor data map of the host vehicle Ego.

Information on a structure around a road may be extracted by fusing the updated sensor data map and sensor data of a lidar (S240).

Location information of the host vehicle may be corrected by matching the extracted information on the structure around the road with a high-definition (HD) map (S250).

As described above, the vehicle of the embodiment may improve the confidence of the sensor data map constructed on the basis of the host vehicle through low-level data sharing with other vehicles in order to solve the problem of map matching performance degradation caused by sensor occlusion. It may be possible to increase the certainty of extraction of feature points on a road by using the sensor data map with improved confidence and to reduce error with respect to the location of the host vehicle by performing map matching through feature points with high certainty. In addition, since a sensor data map for road structures around the vehicle may be provided, it may be possible to determine and remove false tracks generated in sections where tracks with dynamic properties cannot be present and to improve recognition performance for road structures such as temporarily installed construction sites.

Although the present disclosure has been described focusing on the embodiment, the embodiment may be merely an example and does not limit the present disclosure, and those of ordinary skill in the art may understand that various modifications and applications may be possible without departing from the essential characteristics of the embodiment. For example, each component specifically described in the embodiment may be modified. Differences related to such modifications and applications should be construed as being included in the scope of the present disclosure defined in the appended claims.

What is claimed is:

1. A vehicle control method comprising:
acquiring low-level sensor information obtained by a host vehicle and information on a structure included in high-definition map information;
selecting a target vehicle to share low-level sensor information with based on the low-level sensor information obtained by the host vehicle and information on the structure included in high-definition map information; and
receiving low-level sensor information of the structure from the target vehicle to update a sensor data map of the host vehicle, and
performing map matching with the high-definition map information through feature points of a road extracted based on the updated sensor data map.

2. The vehicle control method of claim 1, wherein the selecting of the target vehicle comprises:
determining whether sensor occlusion has occurred in a sensor beam section; and
selecting the target vehicle based on the low-level sensor information obtained in the corresponding section when sensor occlusion has occurred.

3. The vehicle control method of claim 2, wherein the determining of whether sensor occlusion has occurred comprises:
calculating an intersection point between a center line of a sensor beam section and the structure included in the high-definition map information;
calculating a distance between the intersection point calculated from the high-definition map information and low-level sensor information obtained from the sensor beam section; and
determining that sensor occlusion has occurred in the corresponding sensor beam section if the distance is equal to or greater than a reference distance.

4. The vehicle control method of claim 2, wherein the selecting of the target vehicle comprises:
checking classification information (classification) and moving attribute information (moving flag) of low-level sensor information obtained in the section where sensor occlusion has occurred; and
selecting the corresponding vehicle as the target vehicle when the classification is set to “car” and the moving flag is “moving”.

5. The vehicle control method of claim 1, wherein the receiving of low-level sensor information of the structure from the target vehicle to update a sensor data map of the host vehicle, and performing of map matching with the high-definition map information through feature points of a road extracted based on the updated sensor data map comprise:
broadcasting a communication ID and GPS-based location information of the host vehicle;
requesting one-to-one communication from a vehicle having location information of the target vehicle; and
receiving the low-level sensor information of the structure from the target vehicle.

6. The vehicle control method of claim 5, wherein the receiving of the low-level sensor information of the structure from the target vehicle to update the sensor map of the host vehicle comprises:
calculating confidence based on the at least one of classification information (classification), moving attribute information (moving flag), data confidence (quality), and sensor measurement value distance information (range) included in the low-level sensor information received from the target vehicle; and
updating corresponding low-level sensor information to the sensor data map when the confidence is equal to or greater than a threshold value.

7. The vehicle control method of claim 6, wherein the calculating confidence comprises calculating higher confidence as a distance of the sensor measurement value distance information (range) becomes shorter.

8. The vehicle control method of claim 1, further comprising:
obtaining the low-level sensor information using at least one of a camera and a radar; and
generating a sensor data map of the host vehicle using the low-level sensor information,
wherein the receiving of the low-level sensor information of the structure from the target vehicle comprises receiving low-level sensor information obtained using at least one of a camera and a radar of the target vehicle.

9. The vehicle control method of claim 8, wherein the performing of map matching with the high-definition map information through feature points of a road extracted based on the updated sensor data map comprises:
obtaining low-level sensor information using a lidar;
generating sensor fusion data by fusing the updated sensor data map and the low-level sensor information of the lidar; and
extracting the feature points of the road based on the sensor fusion data.

10. The vehicle control method of claim 1, wherein the sensor data map is generated by storing probability that the low-level data is obtained at a specific position in a form of a grid map based on the low-level data.

11. The vehicle control method of claim 10, wherein a size of the sensor data map is determined in advance based on track data and low-level data of a radar and a camera, and information accumulated from a start time at which the low-level data is obtained to a time t is stored in the sensor data map.

12. The vehicle control method of claim 11, wherein the sensor data map is updated in such a manner that the low-level sensor information received from the target vehicle is accumulated and updated in a corresponding cell.

13. A non-transitory computer-readable recording medium recording a program for executing a vehicle control method,
wherein the program implements:
acquiring low-level sensor information obtained by a host vehicle and information on a structure included in high-definition map information;
a function of selecting a target vehicle to share low-level sensor information with based on the low-level sensor information obtained by the host vehicle and information on the structure included in high-definition map information; and
a function of receiving low-level sensor information of the structure from the target vehicle to update a sensor data map of the host vehicle, and performing map matching with the high-definition map information through feature points of a road extracted based on the updated sensor data map.

14. A vehicle comprising:
a sensor unit configured to obtain low-level sensor information on objects around the vehicle;
a communication unit configured to transmit/receive data to/from other vehicles through short-range communication; and
a controller configured to select a target vehicle to share low-level sensor information with based on the low-level sensor information obtained through the sensor unit and information on a structure included in high-definition map information, to receive low-level sensor information of the structure from the target vehicle through the communication unit to update a sensor data map of the vehicle, and to perform map matching with the high-definition map information through feature points of a road extracted based on the updated sensor data map.

15. The vehicle of claim 14, wherein the controller is configured to calculate an intersection point between the structure included in the high-definition map information and a center line of a sensor beam section, calculate a distance between the intersection point calculated from the high-definition map information and low-level sensor information obtained in the sensor beam section, and determine that sensor occlusion has occurred in the sensor beam section if the distance is equal to or greater than a reference distance to select the target vehicle.

16. The vehicle of claim 15, wherein the controller is configured to check classification information (classification) and moving attribute information (moving flag) of low-level sensor information obtained in a section where sensor occlusion has occurred, and select a corresponding vehicle as the target vehicle when classification is set to “car” and the moving flag is “moving”.

17. The vehicle of claim 14, wherein the controller is configured to calculate confidence based on the at least one of classification information (classification), moving attribute information (moving flag), data confidence (quality), and sensor measurement value distance information (range) included in the low-level sensor information received from the target vehicle and update corresponding low-level sensor information to the sensor data map when the confidence is equal to or greater than a threshold value.

18. The vehicle of claim 14, wherein the communication unit is configured to broadcast a communication ID and GPS-based location information of the vehicle according to control of the controller, request one-to-one communication from a vehicle having location information of the target vehicle, and receives low-level sensor information of the structure from the target vehicle.

19. The vehicle of claim 14, wherein the sensor unit includes at least two of a lidar sensor, a camera sensor, and a radar sensor.
